(19) United States
(12) Patent Application Publication
(10) Pub. No.: US 2017/0055544 A1
(43) Pub. Date: Mar. 2, 2017

(54) Cake Decorating Kit

(71) Applicant: Stamp a Cake Pty Ltd, Sumner (AU)

(72) Inventor: Catherine Slatter, Sumner (AU)

(21) Appl. No.: 15/244,335

(22) Filed: Aug. 23, 2016

(30) Foreign Application Priority Data
Aug. 24, 2015 (AU) 2015101160

(51) Int. Cl. A23G 3/28; A23G 3/34; A23P 20/15; A21D 13/00

(52) U.S. Cl. CPC A23G 3/28; A21D 13/0087; A23G 3/343; A23P 20/15

(57) ABSTRACT

The present invention relates to a food grade applicator for marking a surface of an edible product. The applicator includes a design for applying to the product.

### TECHNICAL FIELD

The present invention generally relates to decorating edible products and, in particular, decorating cakes.

### BACKGROUND ART

Traditionally cakes have been used to celebrate special occasions such as birthdays, weddings and religious holidays. More recently, cakes have also been used to promote commercial enterprises.

Cakes are often customised in accordance with each special occasion. Customisation typically includes exteriorly decorating the cake according to the special occasion at hand. For example, patterns or designs are often hand painted or pipped onto the outer surfaces of cakes in accordance with a theme for the occasion or simply to enhance the attractiveness of the cake.

Various techniques are used in decorating the outer surface of cakes. Such techniques include painting, piping, icing, stencilling, moulding and sculpting to list a few.

Many of the techniques listed above, in particular, stencilling and painting can be time consuming and require meticulous application. If a minor mistake is made by the decorator, then the decorator may have to start over. Accordingly, it would be advantageous for a decorator to use a tool to aid the application of decorations to a cake that is quick and easy to use.

The preferred embodiment of the present invention provides an improved applicator for use during cake decorating.

It will be clearly understood that, if a prior art publication is referred to herein, this reference does not constitute an admission that the publication forms part of the common general knowledge in the art in Australia or in any other country.

### SUMMARY OF INVENTION

The present invention is directed to a method and apparatus for cake decorating, which may at least partially overcome at least one of the abovementioned disadvantages or provide the consumer with a useful or commercial choice.

According to one aspect of the present invention, there is provided a food grade applicator for marking a surface of an edible product, the applicator including a design for applying to the product.

Advantageously, the design may be consistently and rapidly applied to the product, over and over again.

Preferably, the food grade applicator is made of a food grade material, for example, a food grade acrylic material. Advantageously, the applicator is safe to use during the preparation of edible products.

In some embodiments, the food grade applicator includes a block portion, and the design includes a decorative portion extending from the block portion such that the decorative portion can be applied to the surface of the edible product. Preferably, the block portion is rectangular in shape and includes an upper surface for mounting a handle and a lower surface for mounting the design. Preferably, the block portion is transparent. Advantageously, the design may be located relative to the product to which the design is to be applied from above with ease. The block portion may include one or more upturned edges. Advantageously, the upturned edges prevent unwanted edge markings from being transferred to the surface of the product during application of the design to the product.

The design may be of any particular shape or combination of shapes. For example, the design may include swirls, numbers, letters, geometric shapes, patterns or pictures. Preferably, the design is smaller in size relative to the block portion. Advantageously, this ensures that that pressure may be applied from the block over the entire surface area of the design during use of the applicator.

Preferably, the design is formed separately from the block. Preferably, the design is replaceable or interchangeable with one or more designs. Advantageously, more than one design may be applied to the product using a single block portion. The design may be made of a material which adheres to the food grade block. Advantageously, the designs are quick and easy to remove and replace from the block portion.

The food grade applicator may include a handle. Preferably, the handle is U-shaped and made of the same or similar material as the block portion. Preferably, the handle is centrally mounted to the block portion on the opposite surface to which the decorative portion extends. Advantageously, the handle may be used to apply pressure to the block portion which may aid in the marking of the product.

In some embodiments, the food grade applicator may be provided in a kit including:

at least one food grade applicator,

edible ink, and

an ink applicator for applying the edible ink to a surface of the at least one food grade applicator.

Preferably, the edible ink may be any food grade ink. Advantageously, the ink is safe to use during the preparation of edible products.

The ink applicator may include a roller for applying ink to the food grade applicator. The roller may include an outer surface for retaining ink from an ink source and transferring the ink to the design portion of the food grade applicator. Preferably, the ink applicator further includes a handle for operating the ink applicator and a rod intermediately located between the handle and the roller for mounting the handle to the roller.

Optionally, the ink applicator may include a cover for covering the roller when not in use. Preferably, the cover substantially encloses the roller to prevent the roller from damage or debris when not in use. The cover may include a base. The base may be substantially planer such that the cover may support the roller in a static upright position when not in use.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a perspective view of a food grade applicator in accordance with an embodiment of the present invention.

FIG. 2 is a view from above of the food grade applicator as shown in FIG. 1 during the application of ink to the food grade applicator.

FIG. 3 is a side view of the food grade applicator as shown in FIG. 1 after the application of ink to the food grade applicator.

FIG. 4 is a view from above of the food grade applicator as shown in FIG. 1 during application to a portion of fondant.

FIG. 5 is a view from above of the portion of fondant as shown in FIG. 4 after application of ink to the fondant using the food grade applicator as shown in FIG. 1.

FIG. 6 is a side view of a cake decorated using the food grade applicator as shown in FIG. 1.

FIG. 7 is a side view of various cakes decorated using the food grade applicator as shown in FIG. 1.

FIG. 8 is a side view of an ink applicator in accordance with an embodiment of the present invention.

FIG. 9 is a table showing different designs in accordance with an embodiment of the present invention.

### DESCRIPTION OF EMBODIMENTS

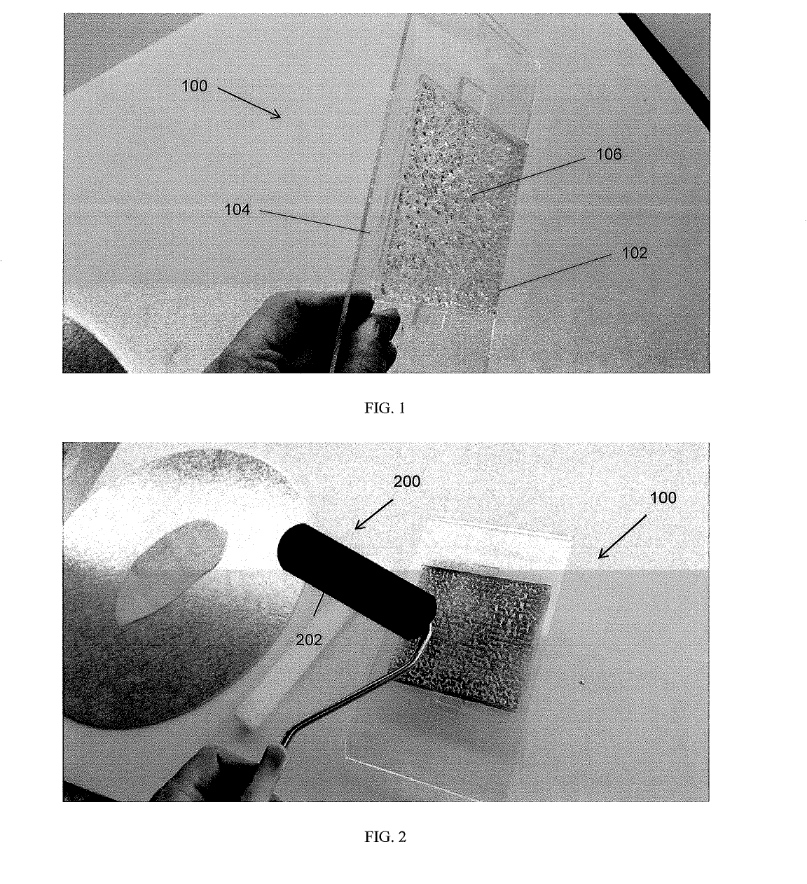

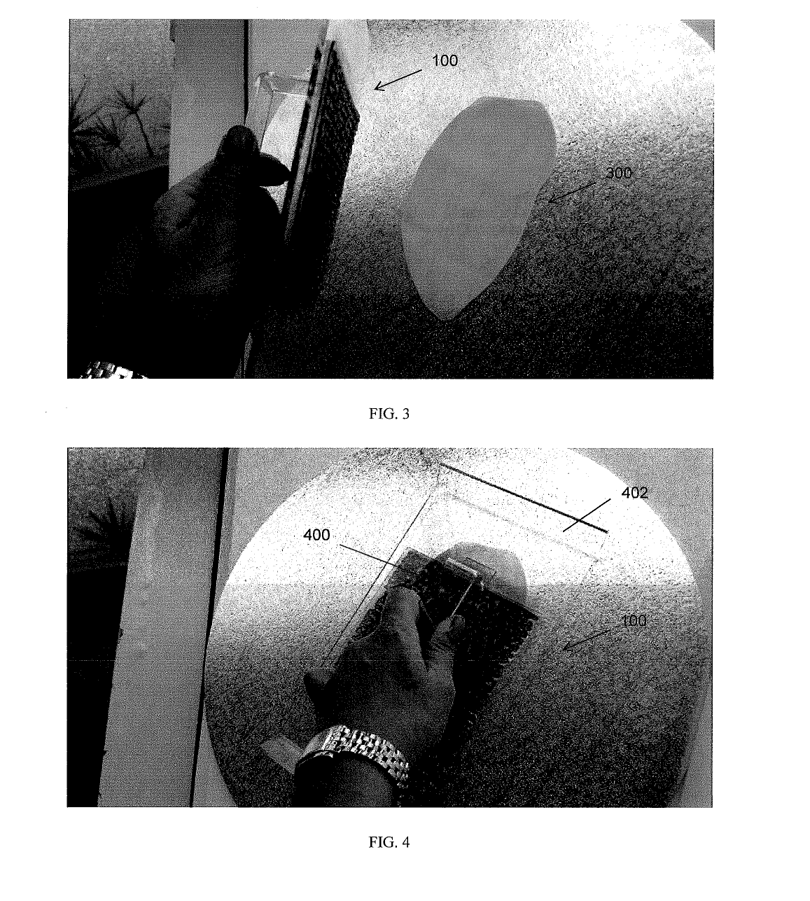

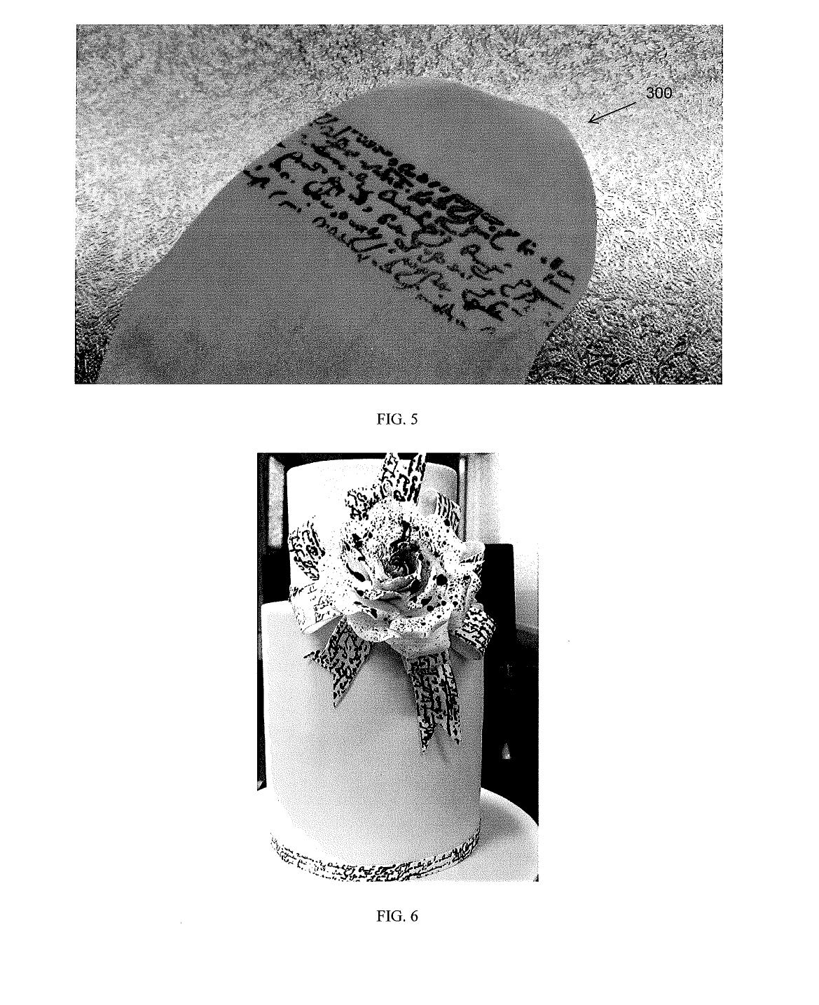

According to a preferred embodiment of the present invention, there is provided a food grade applicator 100, as shown in FIG. 1, for marking a surface of an edible product 300, as shown in FIGS. 3 and 4. The applicator 100 includes a design 102 for applying to the product 300. Advantageously, the design 102 may be consistently and rapidly applied to the product 300, over and over again.

The food grade applicator 100 is made of a food grade material. For example, a food grade acrylic material. A person skilled in the art, however, would understand that any suitable food grade material may be used. Advantageously, the applicator is safe to use during the preparation of edible products.

As shown in FIG. 1, the food grade applicator 100 includes a block portion 104, and the design 102 includes a decorative portion 106 extending from the block portion 104 such that the decorative portion 106 can be applied to the surface of the edible product 300. The block portion is typically rectangular in shape and includes an upper surface for mounting a handle 400 and a lower surface for mounting the design 102. In a preferred embodiment, the block portion is transparent. However, a person skilled in the art would understand that the block portion might be tinted. Advantageously, the design 102 may be located relative to the product 300 to which the design 102 is to be applied from above with ease.

As best shown in FIG. 4, the block portion may further include one or more upturned edges 402. Advantageously, the upturned edges prevent unwanted edge markings from being transferred to the surface of the product during application of the design to the product.

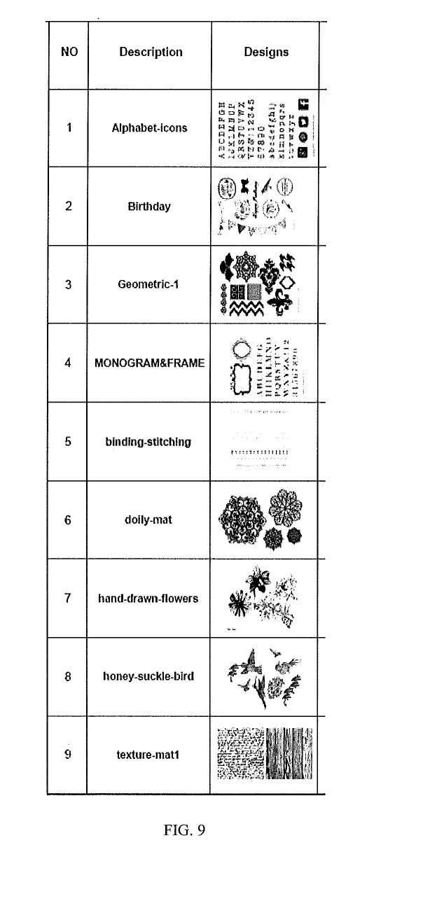

In the embodiment shown in the drawings, the design 102 comprises a script writing decorative portion 106. However, a person skilled in the art would understand that the decorative portion 106 may be of any particular shape or combination of shapes. For example, the decorative portion 106 may include any one or more of swirls, numbers, letters, geometric shapes, patterns or pictures as shown in FIG. 9.

The design 102 is typically smaller in size relative to the block portion 104. Advantageously, this ensures that that pressure may be applied from the block 104 over the entire surface area of the design 102 during use of the applicator 100.

In the preferred embodiment, the design 102 is formed separately from the block portion 104. The design 102 is replaceable or interchangeable with one or more other designs. Advantageously, more than one design 102 may be applied to the product 300 using a single block portion 104. The design 102 may be made of a material which adheres to the block portion 104. Advantageously, the designs 102 are quick and easy to remove and replace from the block portion 104.

A person skilled in the art, however, would understand that the design and the block portion may be integrally formed in other embodiments.

The food grade applicator includes a handle 400. Preferably, the handle 400 is U-shaped and made of the same or similar material as the block portion 104. Preferably, the handle 400 is centrally mounted to the block portion 104 on the opposite surface to which the decorative portion extends 106. Advantageously, the handle 400 may be used to apply pressure to the block portion 104 which may aid in the marking of the product 300.

In use, ink is applied to a bottom most surface of the food grade applicator 100 using any suitable means (for example, an ink applicator). The food grade applicator 100 is then located relative to the surface of an edible product 300 to which the decorator wishes to mark. The decorator then applies pressure to the food grade applicator 100 such that even pressure is applied to the surface area of the design from above which aids in the transfer of the design to the surface of the edible product 300. The food grade applicator 100 may then be removed from the surface of the edible product 300 leaving behind an ink marking corresponding to the decorative portion 106.

Alternatively, ink need not be applied. In which case, the mark may be an imprint of the decorative portion 106.

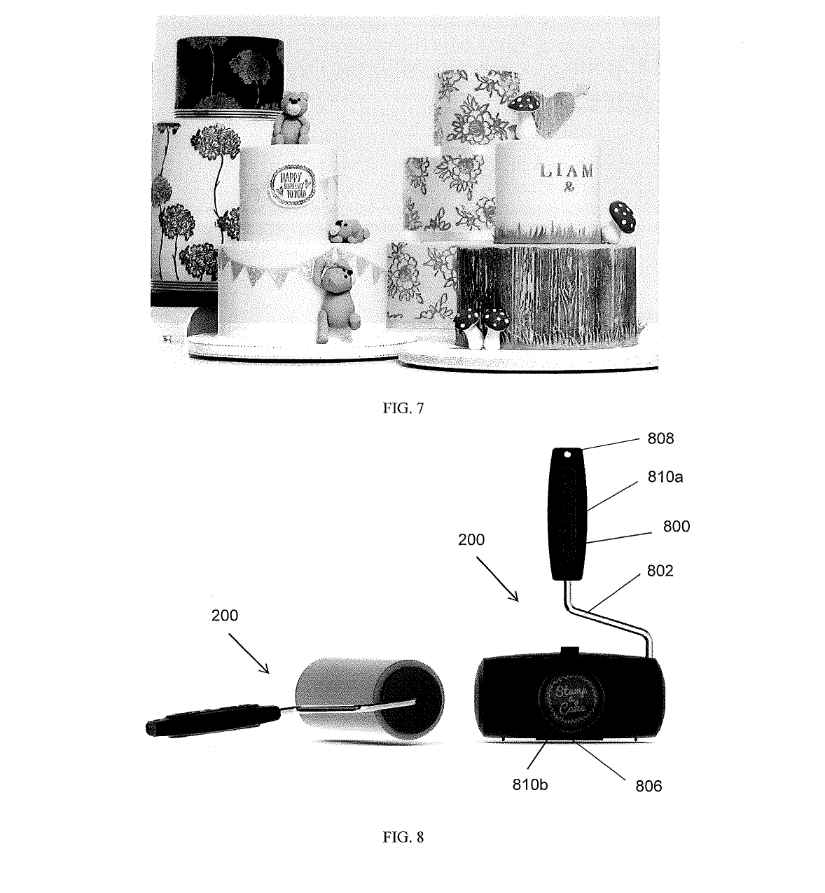

Examples of various finished cake products (i.e. editable products 300) are shown in FIGS. 6 and 7. A person skilled in the art would understand that the food grade applicator 100 may be used to mark other editable products, for example, cupcakes, cookies or pastries.

In another embodiment, the food grade applicator is provided in a kit. The kit includes at least one food grade applicator 100, edible ink (not shown) and an ink applicator 200 for applying the edible ink to a surface of the at least one food grade applicator 100.

A person skilled in the art would understand that the edible ink is any food grade ink. Advantageously, the ink is safe to use during the preparation of edible products.

The ink applicator 200 includes a roller 202 for applying ink to the food grade applicator 100. The roller 202 may include an outer surface for retaining ink from an ink source and transferring the ink to the design portion of the food grade applicator 100. In some embodiments, the ink source may be an ink pad or another other external ink holder. In other embodiments, the ink source may be side the roller.

As best shown in FIG. 8, the ink applicator 200 further includes a handle 800 for operating the ink applicator 200 and a rod 802 intermediately located between the handle 800 and the roller 202 for mounting the handle 800 to the roller 202. The handle 800 is generally elongate and over moulded onto an end of the rod 802. The handle includes an aperture 808 for handing the roller 202 from a hook or other handing means known to the person skilled in the art.

The rod 802 includes an elongate piece of metal which extends from one side of roller 202 and is bent at two locations such that the handle 800 attached to the rod 802 extends vertically away from the middle of the roller 202.

The ink applicator 202 further includes a cover 804 for covering the roller 202 when not in use. The cover substantially encloses the roller 202 to prevent the roller 202 from damage or debris when not in use. The cover 804 includes a base 806. The base 806 may be substantially flat such that the cover 804 may support the roller 202 in a static upright position when not in use.

The ink applicator further includes areas 810a, 810b for embedding advertising indicia.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A food grade applicator for marking a surface of an edible product, the applicator including a design for applying to the product.

2. A food grade applicator as claimed in claim 1 including a block portion, the design including a decorative portion extending from the block portion such that the decorative portion can be applied to the surface of the edible product.

3. A food grade applicator for marking a surface of an edible product as claimed in claim 2, wherein the block portion is made from a transparent material.

4. A food grade applicator for marking a surface of an edible product as claimed in claim 2, wherein the block portion includes one or more upturned edges.

5. A food grade applicator for marking a surface of an edible product as claimed in claim 2, wherein the design is smaller in size relative to the block portion.

6. A food grade applicator for marking a surface of an edible product as claimed in claim 2, wherein the block portion and the design are integrally formed.

7. A food grade applicator for marking a surface of an edible product as claimed in claim 2, wherein the block portion includes a lower surface for mounting the design.

8. A food grade applicator for marking a surface of an edible product as claimed in claim 7, wherein the design is made of a material which adheres to the block portion.

9. A food grade applicator for marking a surface of an edible product as claimed in claim 2, wherein the block portion includes an upper surface for mounting a handle.

10. A food grade applicator for marking a surface of an edible product as claimed in claim 9, wherein the handle is centrally mounted to the block portion.

11. A food grade applicator for marking a surface of an edible product as claimed in claim 9, wherein the block and handle are made of a food grade material.

12. A food grade applicator for marking a surface of an edible product as claimed in claim 2, wherein the decorative portion is replaceable or interchangeable with one or more designs.

13. A food grade applicator for marking a surface of an edible product as claimed in 2, wherein the decorative portion includes swirls, numbers, letters, geometric shapes, patterns and/or pictures.

14. A food grade applicator as claimed in claim 1, wherein the applicator is made of a food grade material.

15. A kit including:
at least one food grade applicator for marking a surface of an edible product, the at least one food grade applicator including a design for applying to the product;
edible ink; and
an ink applicator for applying the edible ink to a surface of the at least one food grade applicator.

16. A kit as claimed in claim 15, wherein the ink applicator includes a roller.

17. A kit as claimed in claim 16, wherein the roller includes an outer surface for retaining ink from an ink source and transferring the ink to the design portion of the food grade applicator.

18. A kit as claimed in claim 16, wherein the ink applicator includes a handle for operating the ink applicator and a rod intermediately located between the handle and the roller for mounting the handle to the roller.

19. A kit as claimed in claim 16, wherein the ink applicator may include a cover for covering the roller when not in use.

20. A kit as claimed in claim 19, wherein the cover includes a substantially planer base.
